(19) United States
(12) Patent Application Publication
(10) Pub. No.: US 2012/0136747 A1
(43) Pub. Date: May 31, 2012

(54) SERVICE CREATION SYSTEM AND IMPLEMENTING METHOD THEREOF

(76) Inventor: Wei Wang, Guangdong Province (CN)

(21) Appl. No.: 13/259,804

(22) PCT Filed: May 14, 2010
(86) PCT No.: PCT/CN2010/072784

§ 371 Date: Jan. 13, 2012

(30) Foreign Application Priority Data
Jul. 21, 2009 (CN) 200910160088.2

(51) Int. Cl. G06Q 30/06

(52) U.S. Cl. 705/26.5

(57) ABSTRACT

The present invention discloses a service creation system and an implementing method thereof. The system comprises: a service creation module for managing and providing service information and service state; a serving access module for managing and providing the serving needed to consist the service; a service execution engine module for, when executing the service, acquiring corresponding service information and service state from the service creation module, acquiring a serving node related when executing a service logic according to the acquired corresponding service information, acquiring corresponding serving information from the serving access module, and invoking a corresponding serving. The present invention improves the service development flexibility.

### FIELD OF THE INVENTION

The present invention relates to the communication field, and in particular to a service creation system and an implementing method thereof.

### BACKGROUND OF THE INVENTION

With the continuous development of communication technologies, various value-added services emerge endlessly. With the emerging of a large number of information products, a series of value-added services arise as the times require, such as short message, multimedia message, streaming media, positioning, etc. These various value-added services on one hand enrich the use requirements of end users and on the other hand increase the income sources of the operators.

However, during the design and marketing process of traditional value-added services, they usually only focus on the promotion in relatively large user groups and this makes those small groups unable to choose freely according to their personal preferences.

The Service Creation Environment (abbreviated as SCE) is a value-added service rapid development tool commonly used by the service developers to help them to develop value-added services rapidly and conveniently. However, since the traditional SCE is oriented to those developers who have programming major background, the difficulty of developing value-added applications is relatively great. The period of development, deployment, and test is relatively long, and it is incapable of meeting people's various personalized demands of services.

It can be seen from the above description that: the current SCE has the following problems: (1) although the SCE abstracts a logic unit operated by it into a service independent building block (SIB) which shields the technical details of the underlying telecommunication network to a great extent, such abstraction is fine granularity abstraction, imposing relatively high requirements on the developers and rendering barriers for those who are not familiar with telecommunication; (2) those services developed using the SCE need to be deployed on the own application server of a service provider; (3) some already implemented application resources can not be used repeatedly; and (4) the SIB in the SCE is provided by the SCE itself, which is enclosed and not open. Therefore, it can be only possible to use the service developing ability of the telecommunication to develop services, which is incapable of combining other abilities, such as Internet ability and information contents.

Therefore, it is urgently needed to provide a combination service providing platform to solve personalized requirements and meet on the basis of personalized improvement the requirements which cannot be achieved by the original mode.

### SUMMARY OF THE INVENTION

The present invention is proposed in light of the problem that the service development flexibility of the current SCE is relatively poor. Therefore the main object of the present invention is to provide an improved service creation system and an implementing method thereof so as to solve the above problems.

A service creation system is provided according to one aspect of the present invention.

The service creation system according to the present invention comprises: a service creation module adapted to manage and provide service information and service state; a serving access module adapted to manage and provide the serving needed to consist the service; a service execution engine module adapted to, when executing the service, acquire corresponding service information and service state from the service creation module, and acquire corresponding serving information from the serving access module according to serving nodes involved in the acquired corresponding service information executing a service logic, and invoke a corresponding serving.

Preferably, the system also comprises: an interface adaptation engine adapted to implement the interaction between the service creation system and one or more external systems other than the service creation system.

Preferably, the interface adaptation engine is also adapted to receive an uplink informing message from an integrated service access gateway in the situation that the external system is the integrated service access gateway.

Preferably, the interface adaptation engine is also adapted to synchronize the service information of an integrated service management system and the service creation system and information of the user using the service, in the situation that the external system is the integrated service management system.

Preferably, the system also comprises: a service creation portal adapted to provide information of the user using the service for a service use management module, provide service information and service state for a service management module, and provide serving for a serving management module according to a service procedure indicated by a user.

Preferably, the service creation portal comprises: a service procedure drafting tool for proving a graphical interface for the user so as to facilitate the user to draft the service procedure.

Preferably, the service creation module is also adapted to perform to the service information and service state at least one of the following operations: inquiry, creation, modification, deletion.

Preferably, the system also comprises: the service use management module adapted to manage the information of the user using the service and invoke the service execution engine module to execute a corresponding service according to service input parameters and a service execution plan indicated by the user.

Preferably, the service use management module is also adapted to perform at least one of the following operations: inquiring the information of the user using the service, managing the user to start or stop the service, managing the service execution plan, and managing a service use call list.

Preferably, the serving access module is also adapted to perform to the serving at least one of the following operations: inquiry, registration, upgrading, and cancellation.

A method for implementing a service creation system is provided according to one aspect of the present invention.

The method for implementing a service creation system according to the present invention comprises: when executing a service, acquiring corresponding service information and service state; and acquiring serving nodes involved when executing a service logic according to the service information, acquiring corresponding serving information according to the serving nodes, and invoking a corresponding serving.

Preferably, acquiring corresponding service information and service state comprises: acquiring respective service input parameters and service execution plan from information of the user using the service and acquiring corresponding service information and service state according to a service needing to be executed in the service execution plan.

Preferably, this method also comprises: setting the information of the user using the service, service information, service state and serving according to a service procedure indicated by the user.

Preferably, this method also comprises: providing a graphical interface for the user indicating the service procedure so as to facilitate the user to draft the service procedure.

Preferably, this method also comprises: performing to the service information and service state at least one of the following operations: inquiry, creation, modification, deletion.

Preferably, this method also comprises: inquiring the information of the user using the service, managing the user starting or stopping service, managing the service execution plan and/or managing a service use call list.

Preferably, this method also comprises: performing to the serving at least one of the following operations: inquiry, registration, upgrading, and cancellation.

By virtue of the present invention, the method of using a service execution engine module and a service creation module and serving access module associated with the service execution engine module to implement service process solves the problem that the service development flexibility of the current SCE is relatively poor, and thus improves the flexibility of service development.

### BRIEF DESCRIPTION OF THE DRAWINGS

The drawings illustrated here provide a further understanding of the present invention and form a part of the present application. The exemplary embodiments and the description thereof are used to explain the present invention without unduly limiting the scope of the present invention. In the drawings:

FIG. 1 is a block diagram of the structure of a service creation system according to the embodiments of the present invention;

FIG. 2 is a first preferred block diagram of the structure of the service creation system according to the embodiments of the present invention;

FIG. 3 is a second preferred block diagram of the structure of the service creation system according to the embodiments of the present invention;

FIG. 4 is a flow chart of a method for implementing a service creation system according to the embodiments of the present invention; and

FIG. 5 is a detailed flow chart of implementing a service creation system according to the examples of the present invention.

### DETAILED DESCRIPTION OF EMBODIMENTS

Considering the problems that the service development flexibility of the current SCE is relatively poor and the personalization cannot be sufficiently met in the traditional value-added service, the embodiments of the present invention provide an improved service creation system and an implementing method thereof. The system comprises the structure in which a service execution engine module, a service creation module, a serving access module, etc are adapted to implement service process. By this system, the user is allowed to make individualized choices of a value-added service on a combination service providing platform, and this system improves the rapidness and flexibility of service development.

It needs to be noted that the embodiments of the present application and the features of the embodiments can be combined with each other in the situation of no conflict. The present invention will be described hereinafter in detail with reference to the drawings and in conjunction with the embodiments. Identical reference numbers are corresponding to identical system unit throughout in all the drawings.

### SYSTEM EMBODIMENTS

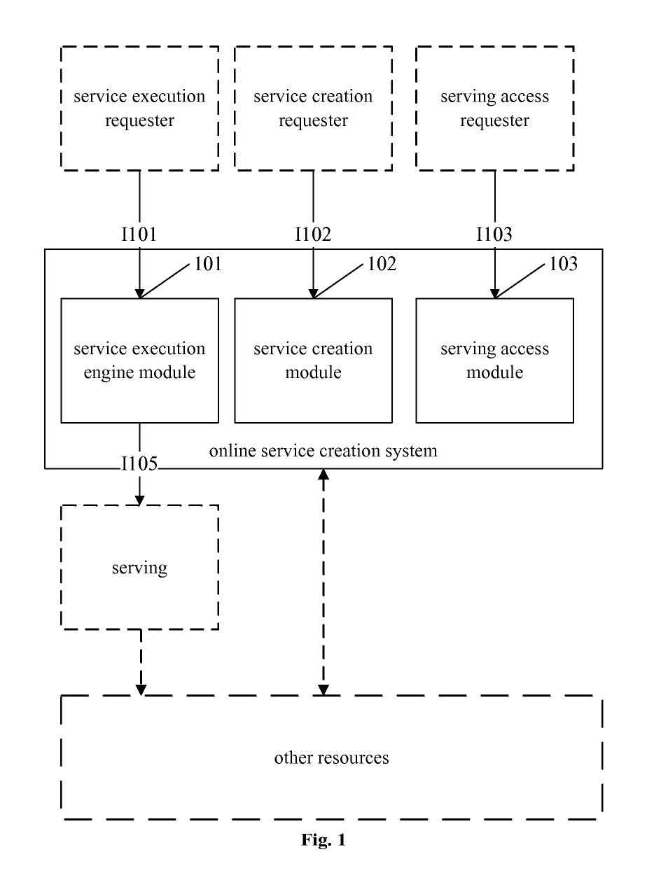

A service creation system (i.e. online service creation system) is provided according to the embodiments of the present invention. FIG. 1 is a block diagram of the structure of a service creation system according to the embodiments of the present invention. As shown in FIG. 1, this system comprises a service execution engine 101, a service creation module 102 and a serving access module 103. The above structure will be described hereinafter.

The serving access module 103 is adapted to manage and provide the serving needed to consist a service; the service creation module 102 is adapted to manage and provide service information and service state; the service execution engine 101, connected to the service creation module 102 and the serving access module 103, is adapted to acquire corresponding service information and service state from the service creation module 102, acquire corresponding service information from the serving access module 103 according to serving nodes involved in the acquired corresponding service information executing a service logic, and invoke a corresponding serving.

Furthermore, the service execution engine 101 can have an interface 1101, which is uniformly referred to as service execution interface 1101 hereinafter. Additionally, the service creation module 102 and the serving access module 103 can also be provided with interface 1102 and 1103 respectively. A service creation requester can communicate with the service creation module 102 via the interface 1102, and a serving access requester can communicate with the serving access module 103 via the interface 1103.

In the embodiment of the present invention, the service execution requester can start the service execution engine 101 via the interface 1101 and input a service execution parameter into the service execution engine 101. Then, the service execution engine 101 executes corresponding service procedure and service logic according to the information carried in the input service execution parameter and invokes a corresponding serving via a specification interface 1105 when executing the service logic, which serving invokes other resources as required via an interface to implement the serving function. The above service execution parameters comprise but are not limited to service procedure identification and service procedure input parameter.

Parameters of a serving specification interface 1105 comprise the serving input parameter and the output parameter. The specification interface 1105 can be a Web Service interface, a REST interface, a program interface, etc.

Additionally, a management requester can start the above service creation module 102 and serving access module 103 by means of communication, and manage via these two modules the relevant information of various services and serving processed by the service execution engine 101.

In particular, the service creation module 102 performs such operations as inquiry, creation, modification, deletion, etc. of the services via the service creation interface 1102.

The service execution engine 101 invokes a corresponding serving via the specification interface 1105. And the serving access module 103 manages the above serving via the serving access interface 1103, which comprises the inquiry, registration, upgrading, cancellation, etc. of the serving.

### Embodiment I

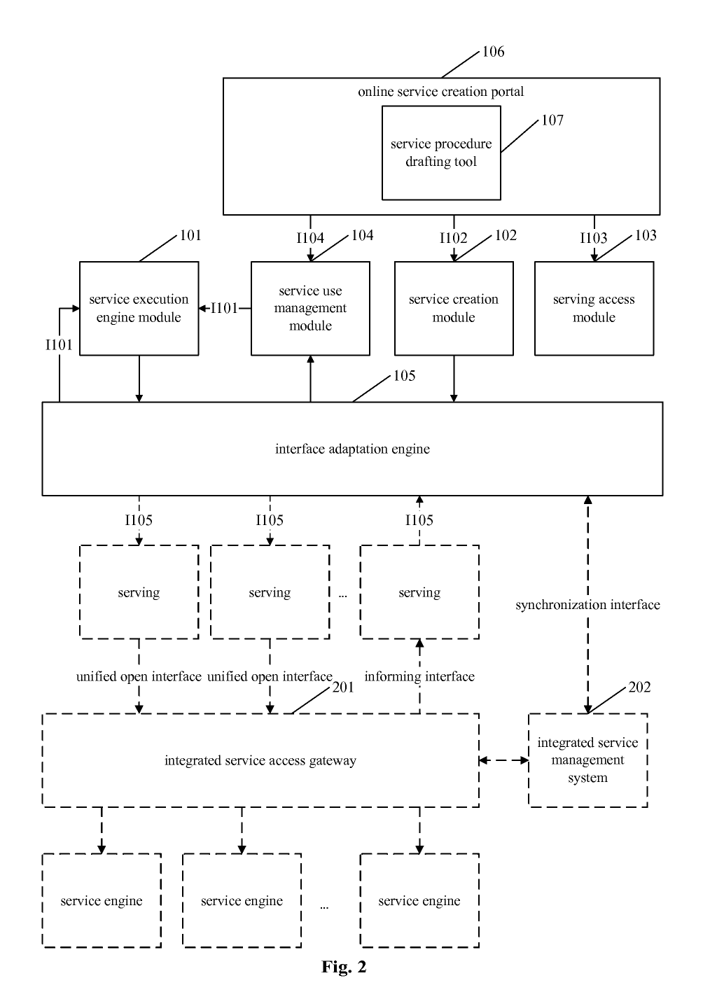

FIG. 2 is a first preferred block diagram of the structure of the service creation system according to the embodiments of the present invention. As shown in FIG. 2, this online service creation system further comprises the following modules besides the above service execution engine 101, service creation module 102, and serving access module 103.

A service use management module 104 is adapted to manage the information of the user using the service and invoke the service execution interface 1101 provided by the service execution engine 101 to execute a corresponding service according to the service input parameter and service execution plan indicated by the user. Additionally, the service use management module 104 performs management on relevant information of user using service via the service management interface 1104, which comprises operations such as inquiry of information of the user using the service, user starting or stopping service, service execution plan, service use call list, etc.

An interface adaptation engine 105 is adapted to implement the interaction of the service creation system and one or more external systems other than the service creation system. That is, the interface adaptation engine 105 is used for an outward interaction interface of the online service creation system.

Specifically, in order to perform integrated regulation and control on various service engines, an integrated service access gateway 201 is set. The interface adaptation engine 105 is further adapted to receive an uplink informing message from the integrated service access gateway 201 forwarded by the serving in the situation that the external system is an integrated service access gateway. And the uplink informing message of the integrated service access gateway 201 is sent to a corresponding serving via an informing interface, then the serving informs the interface adaptation engine 105 via the specification interface 1105 to match corresponding service procedure and input parameter, and thus invoke the service execution engine. Thus, the service execution engine 101 invokes a serving via the interface adaptation engine 105 when executing a service procedure, therefore shielding the difference of the serving interfaces. The invoked services are connected to the integrated service access gateway 201 via a unified open interface, and the integrated service access gateway 201 is connected to the service engine.

On the other hand, the service creation module 102 synchronizes service information with the integrated service management system 202 via the interface adaptation engine 105. The interface adaptation engine 105 is further adapted to synchronize the service information and information of the user using the service of the integrated service management system 202 and the service creation system in the situation that the external system is the integrated service management system 202. That is, the integrated service management system 202 synchronizes the information of the user using the service with the service use management module 104 by the interface adaptation engine 105 via the synchronization interface.

Preferably, the above service creation system further comprises: a service creation portal 106 adapted to provide information of the user using the service for the service use management module, provide service information and service state for the service creation module, and provide serving information for the serving access module, according to a service procedure indicated by a user.

In the process shown in FIG. 1, since the service creation module 102 and the serving access module 103 provide the interface service creation interface 1102 and the serving access interface 1103 used for a requester to perform direct operations to the above modules. However, in this embodiment, the above online service creation system, by using the online service creation portal 106 as a corresponding requester, performs service management and serving management, etc. on each management function in the above module blocks (i.e. the above service creation module 102 and serving access module 103) via the above interfaces.

The online service creation portal 106 further comprises: a service procedure drafting tool 107 adapted to provide a graphical interface to a user to facilitate the user to draft the service procedure. The draft of service procedure can be performed by means of dragging and dropping. The service procedure can be consisted of a start node, a sub-service procedure, a serving node, an expression node, a timer node, a connection wire, etc. This drafting tool can set the attributes of these elements to draft the service procedure by dragging and dropping these types of procedure elements.

### Embodiment II

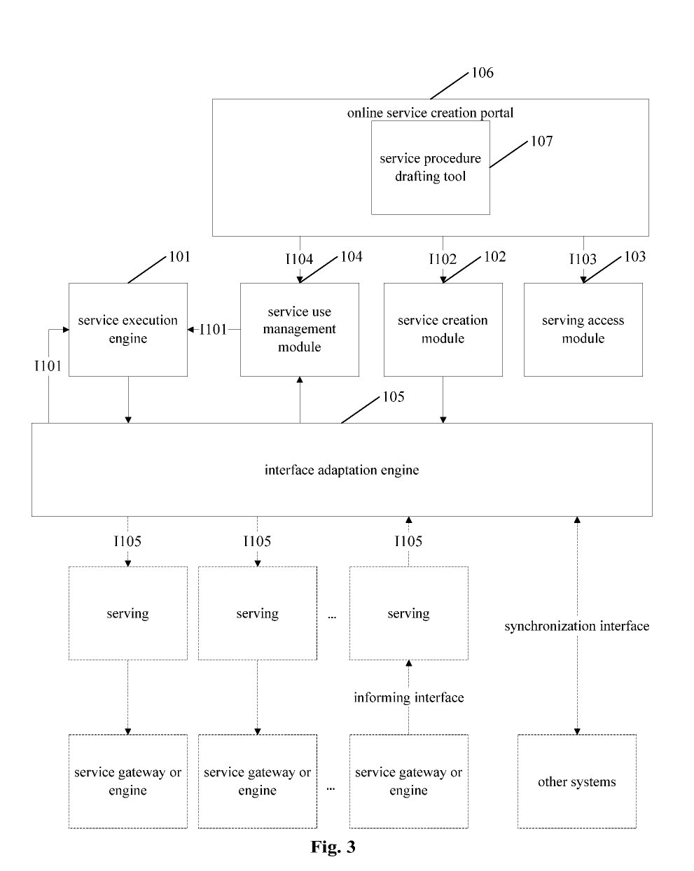

FIG. 3 is a second preferred block diagram of the structure of the service creation system according to the embodiments of the present invention. As shown in FIG. 3, the difference of this embodiment and embodiment I is that: in this embodiment, there is no integrated service access gateway and integrated service management system; but the serving communicates and interacts with each different service gateway or engine respectively, and the interface adaptation engine 105 communicates with other systems via a synchronization interface; therefore, the embodiment shown in FIG. 3 can be adaptive to the different outward system interactions.

### Method Embodiments

A method for implementing a service creation system is provided according to the embodiments of the present invention. This method comprises: when executing a service, acquiring corresponding service information and service state; and acquiring serving nodes involved in executing a service logic according to the service information, acquiring corresponding serving information according to the serving nodes, and invoking a corresponding serving. In particular, acquiring corresponding service information and service state comprises: acquiring a corresponding service input parameter and service execution plan from the information of the user using the service and acquiring corresponding service information and service state according to a service needed to be executed in the service execution plan.

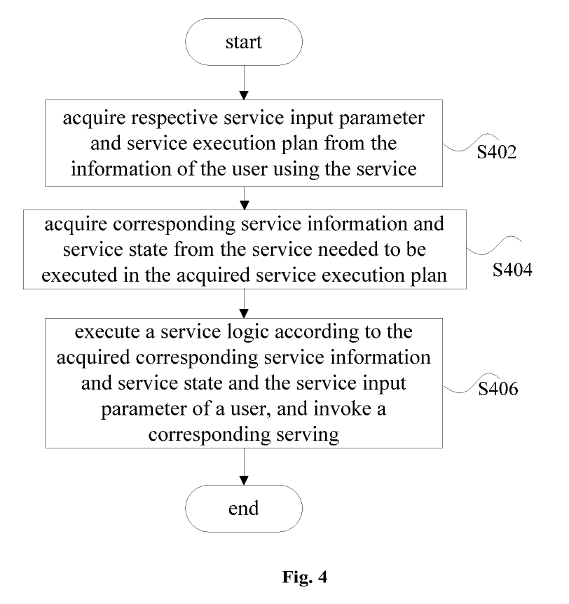

FIG. 4 is a flow chart of a method for implementing a service creation system according to the embodiments of the present invention. As shown in FIG. 4, this method in particular comprises the following steps 402 to 406:

Step 402: acquiring the respective service input parameter and service execution plan from the information of the user using the service;

Step 404: acquiring corresponding service information and service state according to the service needed to be executed in the acquired service execution plan; and

Step 406: executing a service logic according to the acquired corresponding service information and service state and the service input parameter of a user, and invoke a corresponding serving.

Furthermore, the above method also comprises: setting the information of the user using the service, service information, service state and serving according to the service procedure indicated by the user; and providing a graphical interface for the user indicating the service procedure, so as to facilitate the user to draft the service procedure.

Additionally, it can further execute the following operations: inquiring, creating, modifying, and deleting the service information and service state; inquiring, registering, upgrading, and cancelling the serving; and inquiring the information of the user using the service, managing the user to start or stop service, managing the service execution plan, and managing the service use call list.

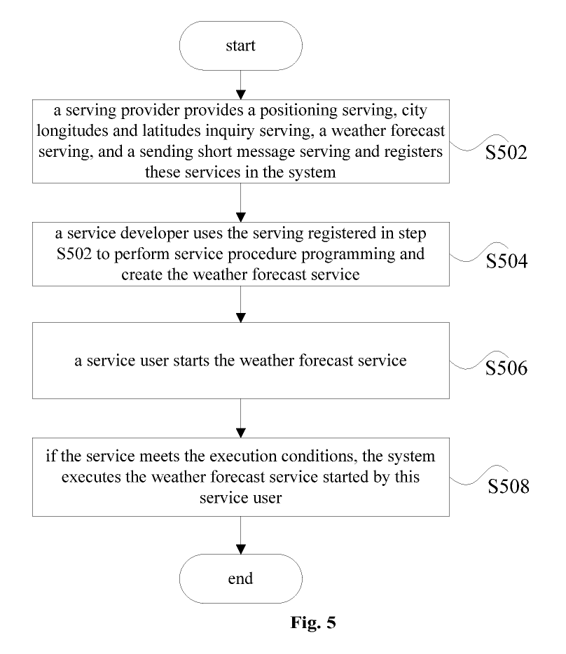

FIG. 5 is a detailed flow chart of a method for implementing a service creation system according to the embodiments of the present invention. As shown in FIG. 5, the procedure of developing and using the weather forecast service in the online service creation system comprises the following steps 502 to 508.

Step 502: A service provider provides a positioning serving, city longitudes and latitudes inquiry serving, a weather forecast serving, and a sending short message serving, and registers these services in the above online service creation system. The positioning serving is to obtain the current longitudes and latitudes of a user according to the user number; the city longitudes and latitudes inquiry serving is to obtain a corresponding city name according to the longitudes and latitudes; the weather forecast serving is to obtain the weather information according to the city name; and the sending short message serving is to send corresponding short message contents to a corresponding destination number in the form of short message according to the destination number and short message contents.

Step 504: A service developer uses the serving registered in step 502 to perform service procedure programming and creates the weather forecast service; the input parameter of the service comprises a destination number; and the procedure of the service is; first executing the positioning serving according to the destination number input by the service, then executing the city longitudes and latitudes inquiry serving according to the longitudes and latitudes output by the positioning serving, and then executing the weather forecast serving according to the city name output by the city longitudes and latitudes inquiry serving, and at last executing the sending short message serving according to the destination number input by the service and the weather information output by the weather forecast serving.

Step 506: A service user starts the weather forecast service. Since this service can set various services as the start node, such as a portal uplink serving used as the start node, a short message uplink serving used as the start node, etc., the service user can configure the input parameter of this service by various means and start this service. For example, by means of short message, a “destination number” is sent to a corresponding “service access code” and the input parameter of this service is configured and this service is started. Also, as shown in FIG. 2 or 3, this service user configures the input parameter and execution plan of this service via the online creation portal 106, and then control the operation of the service use management module 104 via the online creation portal 106, thus configuring the input parameter of this service and starting this service as planned.

Step 508: If the service meets the execution conditions, the system executes via the service execution engine the weather forecast service started by this service user. The current longitudes and latitudes of the user are obtained according to a corresponding destination number, and then the corresponding city name is obtained according to the obtained longitudes and latitudes, then the weather information is obtained according to the city name, and then the obtained weather information is sent via short messages to the destination number set by the user, thus the corresponding destination number receives the weather forecast short message of the current city where the user is currently located.

It can be understood that the above procedure is only an exemplary process used by the system according to the present invention and each step of the individual processes can be swapped as required.

In summary, an improved service creation system and an implementing method thereof are provided by the above embodiments of the present invention. The system comprises the structure in which, a service execution engine, a service creation module, a serving access module, etc are adapted to implementing service process. It solves the problems that the flexibility of service development of the current SCE is relatively poor and the personalization cannot be sufficiently met in the traditional value-added service. And it makes user able to individually choose a value-added service on a combination service providing platform and is able to improve the rapidness and flexibility of service development.

Apparently, those skilled in the art should understand that each module or step in the above present invention can be implemented through general-purpose computing devices and they can be put together on single computing devices or distributed on a network consisted of a plurality of computing devices. Optionally, they can be implemented using computing device executable program code. Therefore, they can be executed by computing devices by storing them in a storage device, or they can be made into each integrated circuit module respectively or they can be implemented by making a plurality of module or steps of them into single integrated module respectively. Thus, the present invention is not limited to the combination of any specific hardware and software.

Above description is only to illustrate the preferred embodiments but not to limit the present invention. Various alterations and changes to the present invention are apparent to those skilled in the art. The scope defined in the present invention shall comprise any modification, equivalent substitution and improvement within the spirit and principle of the present invention.

1. A service creation system, comprising:
a service creation module adapted to manage and provide service information and service state;
a serving access module adapted to manage and provide the serving needed to consist the service; and
a service execution engine module adapted to, when executing a service, acquire corresponding service information and service state from the service creation module, acquire corresponding serving information from the serving access module according to serving nodes involved in the obtained corresponding service information executing a service logic, and invoke a corresponding serving.

2. The system according to claim 1, wherein the system further comprises:
an interface adaptation engine adapted to implement the interaction between the service creation system and one or more external systems other than the service creation system.

3. The system according to claim 2, wherein the interface adaptation engine is further adapted to receive an uplink informing message from an integrated service access gateway in the situation that the external system is the integrated service access gateway.

4. The system according to claim 2, wherein the interface adaptation engine is further adapted to synchronize service information of an integrated service management system and the service creation system and information of the user using the service, in the situation that the external system is the integrated service management system.

5. The system according to claim 1, wherein the system further comprises:
a service creation portal adapted to provide the information of a user using the service for the service use management module, provide the service information and the service state for the serving management module, and provide the serving for the serving management module, according to a service procedure indicated by the user.

6. The system according to claim 5, wherein the service creation portal comprises:
a service procedure drafting tool adapted to provide a graphical interface for a user so as to facilitate the user to draft the service procedure.

7. The system according to claim 1, wherein the service creation module is further adapted to perform to the service information and the service state at least one of the following operations: inquiry, creation, modification, and deletion.

8. The system according to claim 1, wherein the system further comprises:
a service use management module adapted to manage the information of the user using the service and invoke the service execution engine module to execute a corresponding service according to service input parameters and a service execution plan indicated by the user.

9. The system according to claim 8, wherein the service use management module is further adapted to perform at least one of the following operations: inquiring the information of the user using the service, managing the user to start or stop the service, managing the service execution plan, and managing a service use call list.

10. The service creation system according to claim 1, wherein the serving access module is further adapted to perform to the serving at least one of the following operations: inquiry, registration, upgrading, and cancellation.

11. A method for implementing a service creation system, comprising:
acquiring corresponding service information and service state when executing a service; and
acquiring serving nodes involved when executing a service logic according to the service information, and acquiring corresponding service information according to the serving nodes, and invoking a corresponding serving.

12. The method according to claim 11, wherein acquiring corresponding service information and service state comprises:
acquiring a corresponding service input parameter and service execution plan from the information of the user using the service and acquiring the corresponding service information and the service state according to the service needed to be executed in the service execution plan.

13. The method according to claim 12, wherein the method further comprises:
setting the information of the user using the service, the service information, the service state and the serving according to a service procedure indicated by a user.

14. The method according to claim 13, wherein the method further comprises:
providing a graphical interface for the user indicating the service procedure, so as to facilitate the user to draft the service procedure.

15. The method according to claim 11, wherein the method further comprises at least one of the followings:
performing to the service information and the service state at least one of the following operations: inquiry, creation, modification, and deletion;
inquiring the information of the user using the service, managing the user to start or stop the service, managing the service execution plan, and/or managing a service use call list; and
performing to the serving at least one of the following operations: inquiry, registration, upgrading, and cancellation.

16. (canceled)

17. (canceled)

18. The method according to claim 12, wherein the method further comprises at least one of the followings:
performing to the service information and the service state at least one of the following operations: inquiry, creation, modification, and deletion;
inquiring the information of the user using the service, managing the user to start or stop the service, managing the service execution plan, and/or managing a service use call list; and
performing to the serving at least one of the following operations: inquiry, registration, upgrading, and cancellation.

19. The method according to claim 13, wherein the method further comprises at least one of the followings:
performing to the service information and the service state at least one of the following operations: inquiry, creation, modification, and deletion;
inquiring the information of the user using the service, managing the user to start or stop the service, managing the service execution plan, and/or managing a service use call list; and
performing to the serving at least one of the following operations: inquiry, registration, upgrading, and cancellation.

20. The method according to claim 14, wherein the method further comprises at least one of the followings:
performing to the service information and the service state at least one of the following operations: inquiry, creation, modification, and deletion;
inquiring the information of the user using the service, managing the user to start or stop the service, managing the service execution plan, and/or managing a service use call list; and
performing to the serving at least one of the following operations: inquiry, registration, upgrading, and cancellation.
